(19) United States
(12) Patent Application Publication
(10) Pub. No.: US 2025/0293869 A1
(43) Pub. Date: Sep. 18, 2025

(54) COMMUNICATION PROTECTION SYSTEM AND COMMUNICATION PROTECTION METHOD

(71) Applicant: Panasonic Automotive Systems Co., Ltd., Kanagawa (JP)

(72) Inventors: Kaoru YOKOTA, Hyogo (JP); Takumaru NAGAI, Osaka (JP); Tomoyuki HAGA, Nara (JP); Jun ANZAI, Kanagawa (JP)

(73) Assignee: Panasonic Automotive Systems Co., Ltd., Kanagawa (JP)

(21) Appl. No.: 19/067,225

(22) Filed: Feb. 28, 2025

(30) Foreign Application Priority Data
Mar. 12, 2024 (JP) 2024-038139
Jun. 12, 2024 (JP) 2024-095140

(51) Int. Cl. H04L 9/08; H04L 9/40

(52) U.S. Cl. CPC H04L 9/0861; H04L 63/0428

(57) ABSTRACT

A communication protection system includes a receiver, a transfer destination determiner, an identifier, a determiner, an encryptor/decoder (encryptor), and a data transferer. The receiver receives communication data. The transfer destination determiner determines a transfer destination of the communication data. The identifier identifies an affiliation of the sending source of the communication data and that of a transfer destination of the communication data. The determiner determines whether to encode the communication data based on the affiliation of the sending source and that of the transfer destination which are identified. The encryptor/decoder outputs the communication data encoded when the determiner has determined to encode the communication data. The data transferer transfers the communication data to the transfer destination.

The present application is based on and claims priority of Japanese Patent Application No. 2024-038139 filed on Mar. 12, 2024, and Japanese Patent Application No. 2024-095140 filed on Jun. 12, 2024.

### FIELD

The present disclosure relates to a communication protection system provided in a vehicle, and the like.

### BACKGROUND

Progression of in-vehicle architecture leads to a known technique of integrating functions of a plurality of electronic control units (ECUs) into one ECU using a virtualization technique. Moreover, there is an increase in vehicles enabling update of software even after users bought vehicles, such as charged upgrade in software defined vehicles (SDVs) or take-in of applications made by a third party. As described above, while convenience to users is improved, importance of protection against attacks from malicious software or security measures such as countermeasures is also increasing.

Due to such a background, a security system has been examined, in which in a software environment of a vehicle dynamically updated, a safety region including functions related to the safety of the vehicle (functions such as drive, turn, or stop) is separated from an external connection region (EP: Entry Point) having an external connection function which might be an invasion port for an attacker, thereby avoiding damage of the functions related to the safety of the vehicle even if the attacker invades into the EP.

For example, Patent Literature (PTL) 1 discloses a technique which provides hierarchical virtualization using a hypervisor, and PTL 2 discloses a technique of dynamically changing a segment configuration called partition of a computer system.

### CITATION LIST

### Patent Literature

PTL 1: Japanese Unexamined Patent Application Publication (Translation of PCT Application) No. 2009-506462
PTL 2: Japanese Patent No. 4199444

### SUMMARY

However, for example, the technique disclosed in PTL 2 can be improved upon.

Thus, the present disclosure provides a communication protection system and the like capable of improving upon the above related art.

The communication protection system according to one aspect of the present disclosure is a communication protection system provided in a vehicle, and includes a receiver, a transfer destination determiner, an identifier, a determiner, an encryptor, and a data transferer. The receiver receives communication data. The transfer destination determiner determines a transfer destination of the communication data. The identifier identifies an affiliation of a sending source of the communication data and an affiliation of the transfer destination of the communication data. The determiner determines whether to encode the communication data, based on the affiliation of the sending source and the affiliation of the transfer destination which are identified. The encryptor outputs the communication data encoded when the determiner has determined to encode the communication data. The data transferer transfers the communication data to the transfer destination.

A communication protection method according to one aspect of the present disclosure is a communication protection method to be executed by a communication protection system provided in a vehicle. In the communication protection method, communication data is received. In the communication protection method, a transfer destination of the communication data is determined. In the communication protection method, an affiliation of a sending source of the communication data and an affiliation of the transfer destination of the communication data are identified. In the communication protection method, it is determined whether to encode the communication data, based on the affiliation of the sending source and the affiliation of the transfer destination which are identified. In the communication protection method, when it has been determined to encode the communication data, the communication data encoded is output. In the communication protection method, the communication data is transferred to the transfer destination.

One aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating one example of the functional configuration of the in-vehicle system according to an embodiment.

FIG. 2 is a block diagram illustrating one example of the functional configuration of the ECU according to the embodiment.

FIG. 3 is a block diagram illustrating one example of the functional configuration of the communication protection system according to the embodiment.

FIG. 4 is a diagram illustrating one example of a routing table.

FIG. 5 is a diagram illustrating one example of an identification table.

FIG. 6 is a diagram illustrating one example of the format of communication data.

FIG. 7 is a flowchart illustrating an example of the operation of the communication protection system according to the embodiment.

FIG. 8 is a diagram illustrating the outline of the communication protection system according to a modification of the embodiment.

### DESCRIPTION OF EMBODIMENT

### Underlying Knowledge Forming Basis of the Present Disclosure

The present inventors found that the technique disclosed in “Background” section has the following problem.

For example, when the segment is introduced into the in-vehicle architecture as in the technique disclosed in PTL 2, there is a possibility that a segment across a plurality of ECUs is present due to restrictions on physical arrangement of the ECU. In such a segment, logically, there is a possibility that even in communication within the same segment, communication data is temporarily transmitted and received via an in-vehicle bus outside the ECUs. There is also a possibility that even in communication within the same segment in the same ECU, depending on the software configuration in the ECU, communication data is temporarily transmitted and received via another segment. In the case above, the communication data that should be shared only within the segment might be intercepted or falsified by software affiliation to another ECU or another segment, impairing confidentiality or completeness of the communication data.

Hereinafter, an embodiment will be specifically described with reference to the drawings.

The embodiments described below all illustrate general or specific examples. Numeric values, shapes, materials, components, arrangement positions of components, and connection forms thereof and the like shown in the embodiment below are exemplary, and should not be construed as limitations to the present disclosure.

### EMBODIMENT

Hereinafter, the communication protection system according to an embodiment (also referred to as “vehicle security system”) will be described.

### [1. In-Vehicle System]

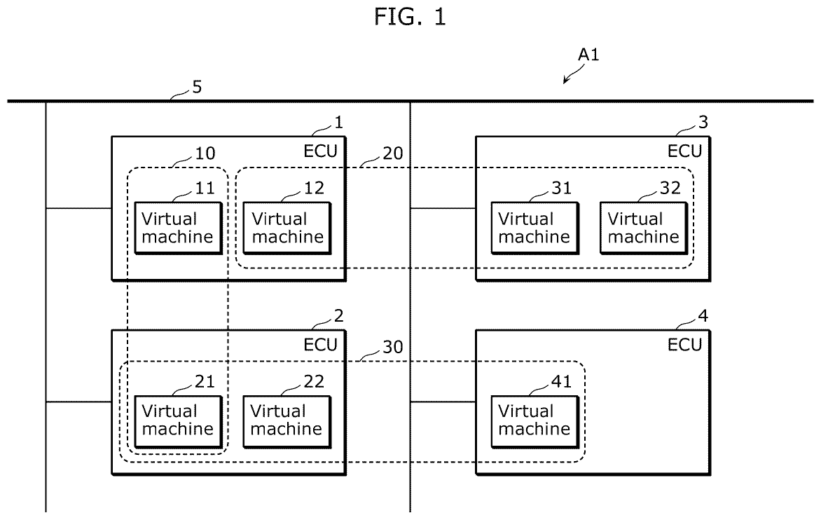

First, in-vehicle system A1 provided with the communication protection system according to an embodiment will be described with reference to FIG. 1. FIG. 1 is a block diagram illustrating one example of the functional configuration of in-vehicle system A1 according to the embodiment. In-vehicle system A1 is provided in a vehicle (one example of a mobile entity). In-vehicle system A1 includes a plurality of (four in this description) ECUs 1 to 4, and in-vehicle bus 5 that connects ECUs 1 to 4.

ECUs 1 to 4 are each a computer including a processor (microprocessor) and memories. The memories are a read only memory (ROM) and a random access memory (RAM), and can store programs to be executed by the processor. In ECUs 1 to 4, a virtualization technique is used to operate one or more virtual computers (virtual machines). In the embodiment, two virtual machines 11 and 12 operate in ECU 1, two virtual machines 21 and 22 operate in ECU 2, two virtual machines 31 and 32 operate in ECU 3, and one virtual machine 41 operates in ECU 4. Communication between the virtual machines within the same ECU is performed through a virtualization environment (described later) within the ECU. On the other hand, communication between the virtual machines in different ECUs is performed through in-vehicle bus 5.

In in-vehicle system A1, a segment composed of one or more virtual machines is defined, and a plurality of virtual machines is logically divided into a plurality of segments. In in-vehicle system A1, while communication between the virtual machines affiliation to the same segment is allowed, communication between the virtual machines affiliation to different segments can be restricted.

Here, the virtual machines each include communication protection system 100 as described later. In other words, communication protection system 100 belongs to one of the segments logically divided. Communication protection system 100 also belongs to one of the ECUs.

The virtual machines disposed in different ECUs can belong to a segment. In other words, the segment may be defined across a plurality of ECUs. The virtual machine can belong to a plurality of segments.

In the embodiment, three segments 10, 20, and 30 are defined as illustrated in FIG. 1. Virtual machine 11 of ECU 1 and virtual machine 21 of ECU 2 belong to segment 10. Virtual machine 12 of ECU 1, and virtual machines 31 and 32 of ECU 3 belong to segment 20. Virtual machines 21 and 22 of ECU 2, and virtual machine 41 of ECU 4 belong to segment 30. Thus, the virtual machines disposed in different ECUs belong to segments 10, 20, and 30. Virtual machine 21 of ECU 2 belongs to two segments 10 and 30.

### [2. ECU]

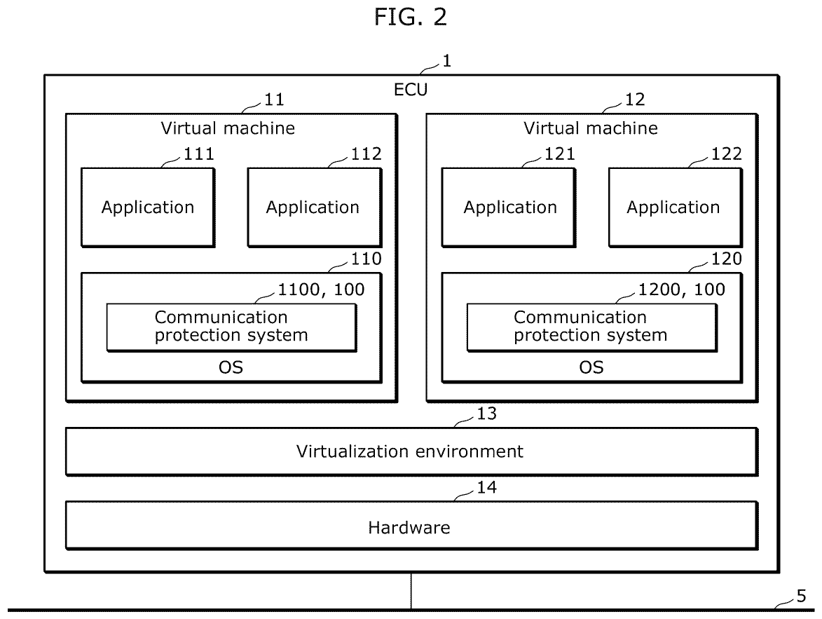

Next, the ECU according to the embodiment will be described. FIG. 2 is a block diagram illustrating one example of the functional configuration of ECU 1 according to the embodiment. ECU 1 includes hardware 14 configured with System On Chip (SoC), for example, and virtualization environment 13 operates in hardware 14. In virtualization environment 13, one or more virtual machines (here, virtual machines 11 and 12) separated from each other are activated, and one or more different operating systems (OSs) (here, OSs 110 and 120) operate in one or more virtual machines.

Hardware 14 is a machine or apparatus capable of receiving data, performing logical operation on data, storing data in a memory, and displaying data on a display. Hardware 14 may include a processor and a memory. Hardware 14 also includes a communication interface for communicating with another hardware in a vehicle by Ethernet, Controller Area Network (CAN), or Serial Peripheral Interface (SPI), for example.

Virtualization environment 13 is a hypervisor, for example, and is software serving as a virtualization basis for operating one or more virtual machines (here, virtual machines 11 and 12).

Virtual machine 11 virtually includes a central processing unit (CPU), a memory, and a disc for storing files, and includes OS 110. In OS 110, one or more applications (here, applications 111 and 112) operate. OS 110 also includes a communication protection system (also referred to as “communication controller”) 1100. As described later, communication protection system 1100 controls communication between the virtual machines, for example, encodes or decodes communication data, or transfer the communication data.

Virtual machine 12 virtually includes a CPU, a memory, and a disc for storing files, and includes OS 120. In OS 120, one or more applications (here, applications 121 and 122) operate. OS 120 also includes a communication protection system (also referred to as “communication controller”) 1200. As described system later, communication protection 1200 controls communication between the virtual machines, for example, encodes or decodes communication data, or transfers the communication data. Hereinafter, when communication protection systems 1100 and 1200 are not particularly distinguished, these are referred to as “communication protection system 100”.

Since the functional configurations of ECUs 2 to 4 are basically the same as the basic configuration of ECU 1, detailed description thereof is omitted. ECUs 2 to 4 each include hardware as in ECU 1, and a virtualization environment operates in the hardware. In the virtualization environment, one or more virtual machines separated from each other are activated, and one or more different OSs operate in one or more virtual machines. In ECUs 2 to 4, as in ECU 1, each of the virtual machines includes communication protection system 100.

### [3. Communication Protection System]

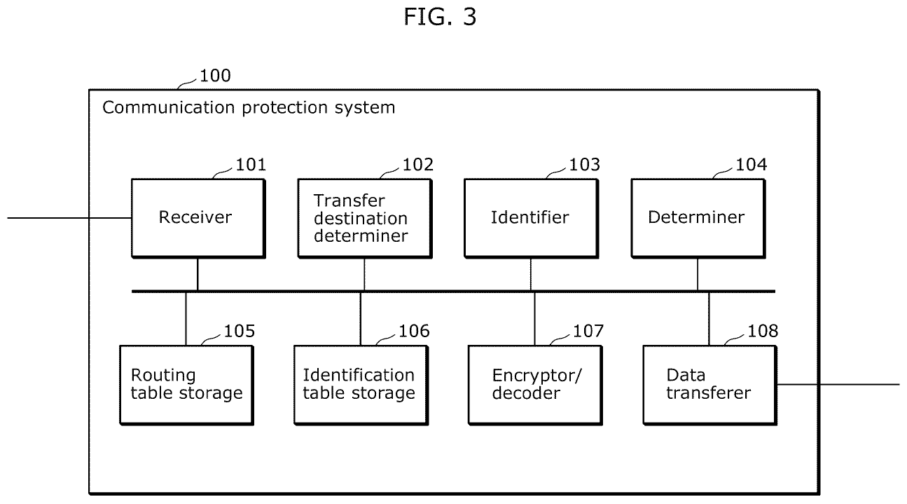

Next, communication protection system 100 according to the embodiment will be described. FIG. 3 is a block diagram illustrating one example of the functional configuration communication protection system 100 according to the embodiment. Communication protection system 100 includes receiver 101, transfer destination determiner 102, identifier 103, determiner 104, routing table storage 105, identification table storage 106, encryptor/decoder 107, and data transferer 108. Here, communication protection system 1100 provided in OS 110 of virtual machine 11 will be described by way of an example. Communication protection system 100 described below is included in the OS of each virtual machine as in OS 110 of virtual machine 11.

Receiver 101 accepts communication data to be transmitted to another virtual machine by a virtual machine (here, virtual machine 11) as an input to communication protection system 100. Receiver 101 also accepts communication data received from another virtual machine by virtual machine (here, virtual machine 11) as an input to communication protection system 100.

Transfer destination determiner 102 determines the transfer destination of the communication data received by receiver 101 by referring to a routing table stored in routing table storage 105. Here, the routing table is a table indicating the virtual machine to which the received communication data is transferred, for each of the virtual machines. Routing table storages 105 of communication protection systems 100 in the virtual machines store the routing tables having different contents.

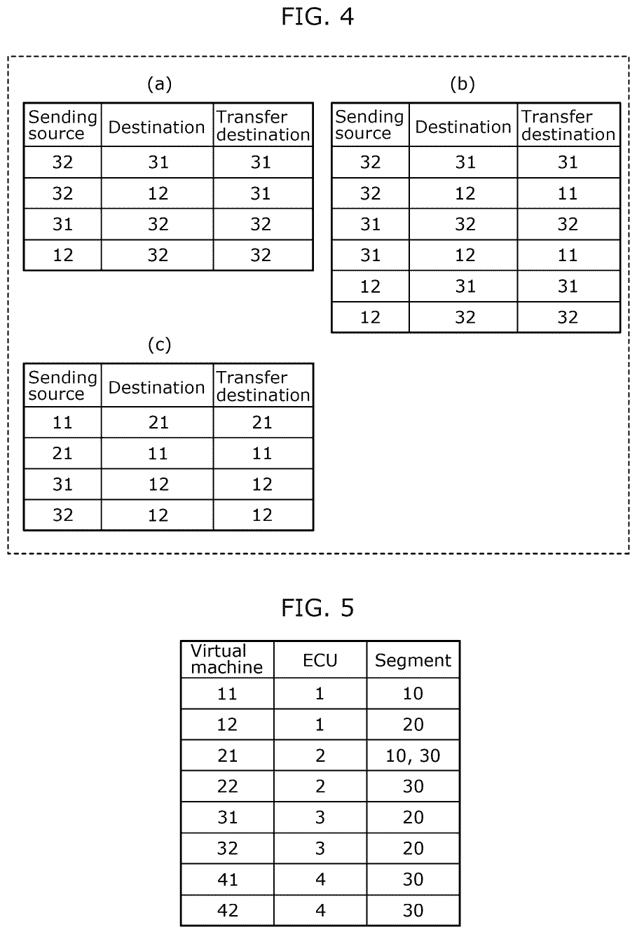

FIG. 4 is a diagram illustrating one example of the routing table. (a) of FIG. 4 illustrates an example of the routing table stored in virtual machine 32 of ECU 3, (b) of FIG. 4 illustrates an example of the routing table stored in virtual machine 31 of EUC3, and (c) of FIG. 4 illustrates an example of the routing table stored in virtual machine 11 of ECU 1. In other virtual machines, the routing tables as illustrated in FIG. 4 are stored.

In the example illustrated in FIG. 4, the routing table indicates the virtual machine as the transfer destination of the communication data corresponding to the combination of a virtual machine as the sending source of the communication data and the destination virtual machine. For example, by referring to the routing table illustrated in (a) of FIG. 4, transfer destination determiner 102 is capable of determining that the communication data whose sending source is virtual machine 32 and whose destination is virtual machine 31 can be transferred to virtual machine 31.

When receiver 101 receives communication data including a combination of the sending source and the destination not indicated in the routing table, transfer destination determiner 102 determines that transfer of the communication data is prohibited, and discards the communication data. For example, when receiver 101 receives the communication data whose sending source is virtual machine 32 and destination is virtual machine 11, by referring to the routing table illustrated in (a) of FIG. 4, transfer destination determiner 102 is capable of determining that transfer of the communication data is prohibited because the combination of “virtual machine 32” as the sending source and “virtual machine 11” as the destination is not indicated in the routing table.

By referring to an identification table stored in identification table storage 106, identifier 103 identifies the ECU and segment to which the virtual machine as the sending source of the communication data received by receiver 101 belongs (hereinafter, generally referred to “affiliation of the virtual machine” for simplicity), and the affiliation of the virtual machine as the transfer destination of the communication data. Here, the identification table is a table indicating the ECU and segment to which each of the virtual machines belongs. Identification table storages 106 of communication protection systems 100 in the virtual machines all store the identification tables having the same contents.

FIG. 5 is a diagram illustrating one example of the identification table. In the example illustrated in FIG. 5, the identification table indicates the ECUs to which virtual machines 11, 12, 21, 22, 31, 32, 41, and 42 belong and the segments to which virtual machines 11, 12, 21, 22, 31, 32, 41, and 42 belong. For example, by referring the identification table illustrated in FIG. 5, identifier 103 is capable of determining that virtual machine 11 belongs to ECU 1 and segment 10, and virtual machine 21 belongs to ECU 2 and segments 10 and 30.

Determiner 104 determines whether to encode the communication data received by receiver 101. Determiner 104 determines whether to decode the communication data received by receiver 101. In the embodiment, determiner 104 determines whether to encode the communication data, based on whether the received communication data is encoded, the affiliation of the virtual machine as the sending source of the communication data identified by identifier 103, and the affiliation of the virtual machine as the transfer destination. Specifically, when encryption flag 60 contained in the communication data (described later) is “1”, i.e., when the communication data is not encoded, determiner 104 determines not to encode the communication data. When encryption flag 60 is “0”, i.e., when the communication data is not encoded, determiner 104 determines not to encode the communication data as long as the condition where the sending source of the communication data and the transfer destination belong to the same segment and belong to the same ECU is satisfied. In contrast, when encryption flag 60 is “0” and the sending source of the communication data and the transfer destination do not satisfy the above condition, determiner 104 determines to encode the communication data.

In the embodiment, when the received communication data is encoded, determiner 104 determines whether to decode the communication data, based on the destination of the communication data. Specifically, when encryption flag 60 contained in communication data is “1”, i.e., when the communication data is encoded and when the destination of the communication data is own virtual machine 11, determiner 104 determines to decode the communication data. In contrast, even if encryption flag 60 contained in communication data is “1”, i.e., even if the communication data is encoded and when the destination of the communication data is not own virtual machine 11, determiner 104 determines not to decode the communication data. When encryption flag 60 contained in communication data is “0”, i.e., when the communication data is not encoded, determiner 104 also determines not to decode the communication data.

Encryptor/decoder 107 outputs the encoded communication data or communication data obtained by decoding the communication data already encoded, based on the result of determination by determiner 104. Specifically, when determiner 104 has determined to encode the communication data, encryptor/decoder 107 encodes the communication data using a cipher key stored in the virtual machine. When determiner 104 determines to decode the communication data, encryptor/decoder 107 decodes the communication data already encoded, using the cipher key stored in the virtual machine. Hereinafter, encryptor/decoder 107 may be exchangeable with “encryptor” when only the encoding processing of the communication data is focused.

In the embodiment, the cipher key used by encryptor/decoder 107 is preliminarily generated to be different among the segments. Each of the virtual machines stores the cipher key for the segment to which the virtual machine belongs. For example, virtual machines 11 and 21 affiliation to segment 10 store the cipher key for segment 10, virtual machines 12, 31, and 32 affiliation to segment 20 store the cipher key for segment 20, and virtual machines 21, 22, and 41 affiliation to segment 30 store the cipher key for segment 30. Virtual machine 21 stores the cipher key for segment 10 and the cipher key for segment 30.

Data transferer 108 transfers the communication data received by receiver 101 (including communication data encoded or decoded by encryptor/decoder 107) to the transfer destination determined by transfer destination determiner 102.

### [4. Operation]

Hereinafter, the operation of communication protection system 100 according to the embodiment when the communication data is transmitted and received between the virtual machines will be described. Here, communication between the virtual machines occurs, for example, when the communication data (also referred to as “application data”) is transmitted from an application on any virtual machine to an application on another virtual machine.

At this time, the application of the sending source designates the application of the destination and instructs to transmit the communication data to the software of a lower layer (software of the OS or lower). The software of a lower layer which has received the instruction converts the application of the sending source and application of the destination into the virtual machine as the sending source and the virtual machine as the destination, and then performs communication between the virtual machines described below. The virtual machine as the destination which has received the communication data identifies the application of the destination from the received communication data, and notifies the application of the communication data. Hereinafter, the description of transmission and reception of the communication data between the software of a lower layer and the application is omitted.

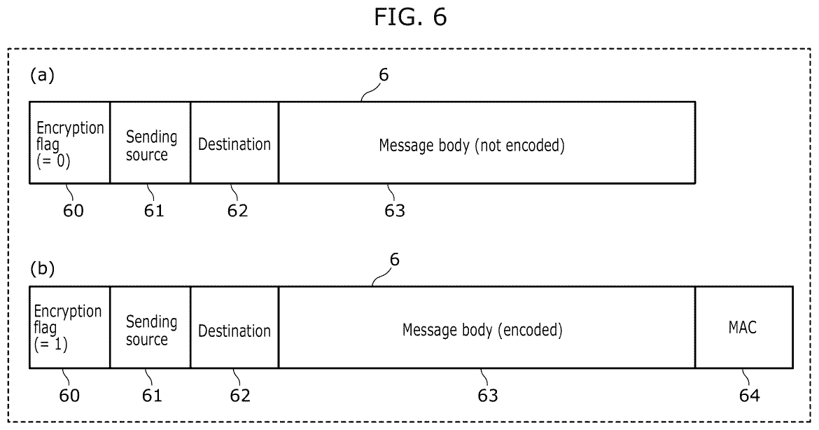

Prior to the description of communication between the virtual machines, the format of the communication data will be described with reference to FIG. 6. FIG. 6 is a diagram illustrating one example of the format of communication data 6. (a) of FIG. 6 illustrates the format when communication data 6 is not encoded, and (b) of FIG. 6 illustrates the format when communication data 6 is encoded. As illustrated in FIG. 6, communication data 6 includes a header and message body 63, the header including three items of information, encryption flag 60, sending source 61, and destination 62. When communication data 6 is encoded, as illustrated in (b) of FIG. 6, communication data 6 further includes message authentication code (MAC) 64 for detecting falsification.

Encryption flag 60 is set to “0” as illustrated in (a) of FIG. 6 when communication data 6 is not encoded, and is set to “1” as illustrated in (b) of FIG. 6 when communication data 6 is encoded. Non-encoded information is stored in both of sending source 61 and destination 62. Message body 63 stores non-encoded data as illustrated in (a) of FIG. 6 when communication data 6 is not encoded, and stores encoded data as illustrated in (b) of FIG. 6 when communication data 6 is encoded.

### <Basic Operation>

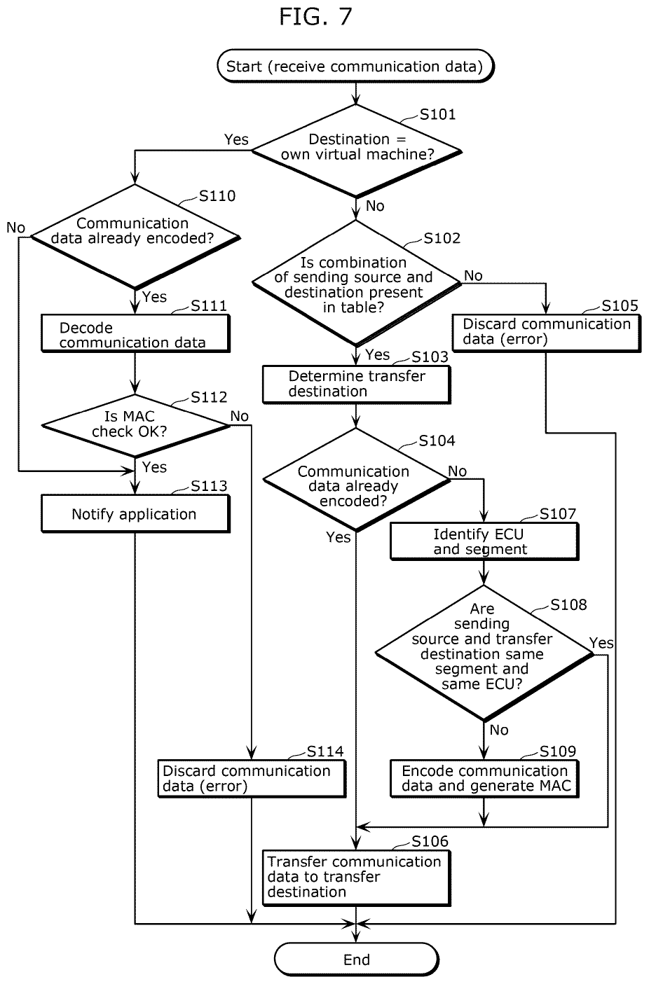

Hereinafter, the basic operation of communication protection system 100 according to the embodiment will be described with reference to FIG. 7. FIG. 7 is a flowchart illustrating an example of the operation of communication protection system 100 according to the embodiment.

First, when receiver 101 in communication protection system 100 receives the communication data, transfer destination determiner 102 determines whether the virtual machine as the destination of the communication data is own virtual machine (S101). When the virtual machine as the destination is not own virtual machine (S101: No), by referring to the routing table, transfer destination determiner 102 determines whether a combination of the sending source of the communication data and the destination is present in the routing table (S102). When the combination is not present in the routing table (S102: No), transfer destination determiner 102 discards the communication data as a communication error (S105).

When the combination is present in the routing table (S102: Yes), transfer destination determiner 102 determines the virtual machine as the transfer destination of the communication data (S103). When the communication data is already encoded (S104: Yes), data transferer 108 transfers the communication data to the virtual machine as the transfer destination (S106).

When the communication data is not encoded (S104: No), by referring to the identification table, identifier 103 identifies the ECU and segment to which the virtual machine of the sending source belongs and the ECU and segment to which the virtual machine as the transfer destination belongs (S107).

Then, determiner 104 determines whether to encode the communication data, based on the affiliation of the virtual machine as the sending source of the communication data and the affiliation of the virtual machine as the transfer destination (S108). When the condition where the virtual machine of the sending source and the virtual machine as the transfer destination are within the same segment and belong to the same ECU (S108: Yes), determiner 104 determines not to encode the communication data. In this case, the communication data is transferred to the virtual machine as the transfer destination without being encoded (S106). On the other hand, when the virtual machine of the sending source and the virtual machine as the transfer destination do not satisfy the above condition (S108: No), determiner 104 determines to encode the communication data.

Then, encryptor/decoder 107 encodes the communication data using the cipher key for the segment to which own encryptor/decoder belongs, generates a MAC, and adds the MAC to the communication data (S109). When the virtual machine belongs to a plurality of segments and stores a plurality of cipher keys, by referring to the identification table, encryptor/decoder 107 uses the cipher key for the segment to which the virtual machine as the destination belongs. The encoded communication data is transferred to the virtual machine as the transfer destination (S106).

Returning to step S101, when the virtual machine as the destination of the communication data is own virtual machine (S101: Yes) and the communication data is not encoded (S110: No), communication protection system 100 notifies the application of the destination corresponding to the communication data of the communication data (S113).

When the communication data is encoded (S110: Yes), encryptor/decoder 107 decodes the communication data using the cipher key for the segment to which own encryptor/decoder belongs (S111). Encryptor/decoder 107 also performs validation of the MAC using the cipher key for the segment to which own encryptor/decoder belongs (S112). When the validation result of the MAC is normal (S112: Yes), communication protection system 100 notifies the application of the destination corresponding to the communication data of the communication data (S113). On the other hand, when the validation result of the MAC is not normal (S112: No), communication protection system 100 discards the communication data as a communication error (S114). When the virtual machine belongs to a plurality of segments and stores a plurality of cipher keys, by referring to the identification table, encryptor/decoder 107 uses the cipher key for the segment to which the virtual machine of the sending source belongs.

### SPECIFIC EXAMPLE

Hereinafter, a specific operation of communication protection system 100 when virtual machine 32 affiliation to ECU 3 transmits the communication data to virtual machine 12 which is ECU 1 as another ECU and belongs to same segment 20 will be described with reference to FIG. 7.

Initially, in the communication data transmitted from virtual machine 32 to virtual machine 12, the encryption flag is “0”, the sending source is “virtual machine 32”, the destination is “virtual machine 12”, the message body is not encoded. At this time, communication protection system 100 of virtual machine 32 first executes step S101, and then executes step S102 because the destination is not own virtual machine (S101: No). By referring to the routing table for virtual machine 32 (see (a) of FIG. 5), communication protection system 100 of virtual machine 32 verifies that a combination of virtual machine 32 as the sending source and virtual machine 12 as the destination is present (S102: Yes), and determines virtual machine 31 as the transfer destination (S103).

Next, communication protection system 100 of virtual machine 32 verifies that the communication data is not encoded (S104: No), and identifies the affiliation of virtual machine 32 as the sending source and the affiliation of virtual machine 31 as the transfer destination by referring to the identification table (see FIG. 4). Since virtual machine 32 as the sending source and virtual machine 31 as the transfer destination belong to same ECU 3 and segment 20 (S108: Yes), communication protection system 100 of virtual machine 32 determines not to encode the communication data. Then, communication protection system 100 of virtual machine e 32 transfers the non-encoded communication data to virtual machine 31 as the transfer destination (S106).

In the communication data transmitted from virtual machine 32 to virtual machine 31, the encryption flag is “0”, the sending source is “virtual machine 32”, the destination is “virtual machine 12”, and the message body is not encoded. At this time, communication protection system 100 of virtual machine 31 first executes step S101, and then executes step S102 because the destination is not own virtual machine (S101: No). By referring to the routing table (see (b) of FIG. 5) for virtual machine 31, communication protection system 100 of virtual machine 31 verifies that a combination of virtual machine 32 as the sending source and virtual machine 12 as the destination is present (S102: Yes), and determines virtual machine 11 as the transfer destination (S103).

Next, communication protection system 100 of virtual machine 31 verifies that the communication data is not encoded (S104: No), and identifies the affiliation of virtual machine 32 as the sending source and that of virtual machine 11 as the transfer destination by referring to the identification table (see FIG. 4). Since ECU 3 and segment 20 to which virtual machine 32 as the sending source belongs are different from ECU 1 and segment 10 to which virtual machine 11 as the transfer destination belongs (S108: No), communication protection system 100 of virtual machine 31 determines to encode the communication data.

Communication protection system 100 of virtual machine 31 encodes the communication data using the cipher key for segment 20 to which virtual machine 31 belongs, generates a MAC, and adds the MAC to the communication data (S109). In the encoded communication data, the encryption flag is “1”, the sending source is “virtual machine 32”, the destination is “virtual machine 12”, the message body is encoded, and the MAC is added thereto. Then, communication protection system 100 of virtual machine 31 transfers the encoded communication data to virtual machine 11 as the transfer destination (S106).

In the communication data transferred from virtual machine 31 to virtual machine 11, the encryption flag is “1”, the sending source is “virtual machine 32”, the destination is “virtual machine 12”, the message body is encoded, and the MAC is added. At this time, communication protection system 100 of virtual machine 11 first executes step S101, and then executes step S102 because the destination is not own virtual machine (S101: No). By referring to the routing table for virtual machine 11 (see (c) of FIG. 5), communication protection system 100 of virtual machine 11 verifies that a combination of virtual machine 32 as the sending source and virtual machine 12 as the destination is present (S102: Yes), and determines virtual machine 12 as the transfer destination (S103).

Next, communication protection system 100 of virtual machine 11 verifies that the communication data is encoded (S104: Yes), and transfers the communication data to virtual machine 12 as the transfer destination (S106).

In the communication data transferred from virtual machine 11 to virtual machine 12, the encryption flag is “1”, the sending source is “virtual machine 32”, the destination is “virtual machine 12”, the message body is encoded, and the MAC is added thereto. At this time, communication protection system 100 of virtual machine 12 first executes step S101, and then executes step S110 because the destination is own virtual machine (S101: Yes). After communication protection system 100 of virtual machine 12 verifies that the communication data is encoded (S110: Yes), communication protection system 100 of virtual machine 12 decodes the communication data using the cipher key for segment 20 to which communication protection system 100 of virtual machine 12 belongs (S111). Communication protection system 100 of virtual machine 12 performs validation of the MAC using the cipher key for segment 20 to which communication protection system 100 of virtual machine 12 belongs (S112). When the validation result of the MAC is normal (S112: Yes), communication protection system 100 of virtual machine 12 notifies an application corresponding to the communication data of the communication data (S113). On the other hand, when validation result of the MAC is not normal (S112: No), communication protection system 100 of virtual machine 12 discards the communication data as an communication error (S114).

### [5. Merits]

Hereinafter, merits of communication protection system 100 according to the embodiment will be described. As described above, communication protection system 100 according to the embodiment, when transferring the communication data, identifies the affiliation of the virtual machine as the sending source of the communication data and that of the virtual machine as the transfer destination of the communication data, and determines whether to encode the communication data, based on these affiliations thereof. When communication protection system 100 according to the embodiment has determined to encode the communication data, communication protection system 100 according to the embodiment transfers the encoded communication data to the transfer destination. Thus, because the communication data is encoded in communication protection system 100 according to the embodiment, the communication data is less likely to be intercepted or falsified by software affiliation to an ECU or segment different from the ECU or segment to which communication protection system 100 belongs. This leads to a merit that the confidentiality and completeness of the communication data is difficult to impair.

In communication protection system 100 according to the embodiment, instead of encoding all the items of communication data, only communication data to be encoded is encoded based on the affiliation of the virtual machine of the sending source and that of the virtual machine as the transfer destination, which leads to a merit that communication delay caused by encoding processing is likely to be suppressed.

### OTHER EMBODIMENTS

Thus, the embodiment has been described as an illustration of the technique according to the present disclosure. However, the technique according to the present disclosure is not limited to this, and is applicable to embodiments obtained by appropriately subjecting the embodiment to change, replacement, addition, and omission. For example, the following modification is also included in one embodiment according to the present disclosure.

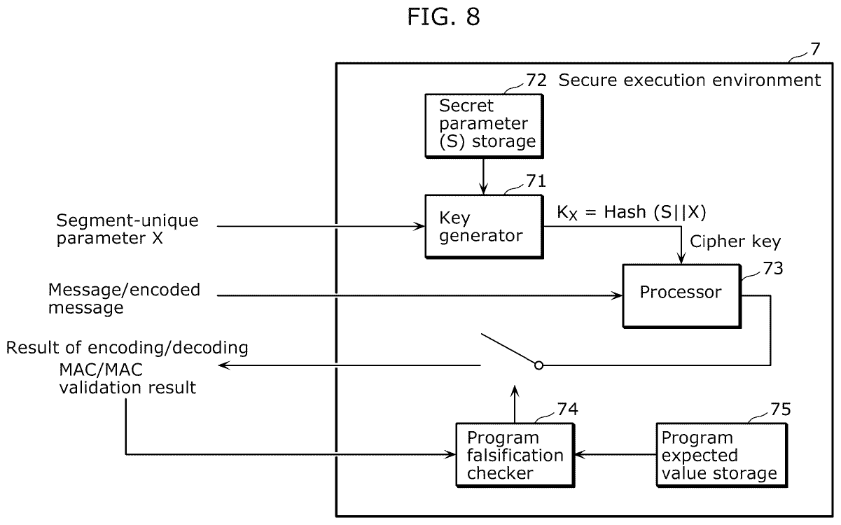

In the embodiment above, encryptor/decoder 107 in communication protection system 100 stores the cipher key for the segment to which own encryptor/decoder belongs, and encodes the communication data using the cipher key, but any other configuration can be used. For example, communication protection system 100 may further include secure execution environment 7 as illustrated in FIG. 8, in which when the communication data is encoded, a cipher key may be generated in secure execution environment 7, and the communication data may be encoded using the generated cipher key.

FIG. 8 is a diagram illustrating an outline of communication protection system 100 according to a modification of the embodiment. As illustrated in FIG. 8, secure execution environment 7 is an execution environment different from the execution environment in which encryptor/decoder (encryptor) 107 executes a program, and is an execution environment that is less likely to be falsified by an attacker than in the execution environment in which encryptor/decoder 107 executes a program. Secure execution environment 7 also stores a unique secret parameter. While the secret parameter is unique to each of vehicles, it is a parameter shared by all the communication protection systems in each vehicle and is used during generation of a cipher key.

Secure execution environment 7 is implemented by a TrustZone (registered trademark) technique, for example. Secure execution environment 7 may be disposed in each ECU as an environment different from virtualization environment 13, for example. Secure execution environment 7 may be implemented by a virtual machine different from the existing one or more virtual machines in virtualization environment 13, for example.

Secure execution environment 7 includes key generator 71, secret parameter storage 72, processor 73, program falsification checker 74, and program expected value storage 75.

Key generator 71 generates a cipher key using a secret parameter stored in secret parameter storage 72 and a segment-unique parameter given by encryptor/decoder 107 when the communication data is encoded or decoded. The segment-unique parameter is a parameter unique to each segment to which the virtual machine including encryptor/decoder 107 belongs, and is stored in the virtual machine. Here, key generator 71 generates the cipher key from an expression Kx=Hash(S∥X) where the cipher key is “Kx”, the segment-unique parameter is “X”, and the secret parameter is “S”. Here, Hash( ) represents a function to perform hash calculation, and S∥X represents data where data S is linked to data X. In other words, key generator 71 calculates a hash value using an appropriate hash function based on the segment-unique parameter and the secret parameter, and defines the calculated hash value as the cipher key.

When processor 73 accepts an instruction from encryptor/decoder 107 to request encoding of the communication data, processor 73 executes encoding processing on the communication data using the cipher key generated by key generator 71. Here, processor 73 encodes the message (communication data) given by encryptor/decoder 107, using the generated cipher key. At this time, processor 73 generates the MAC using the generated cipher key, and adds the MAC to the communication data.

When processor 73 accepts an instruction from encryptor/decoder 107 to request decoding of the communication data already encoded, processor 73 executes processing to decode the communication data already encoded, using the cipher key generated by key generator 71. Here, processor 73 decodes the encoded message (the communication data already encoded) given by encryptor/decoder 107, using the generated cipher key. At this time, processor 73 also executes processing to validate the MAC, using the generated cipher key.

Program falsification checker 74 determines whether the program being executed by encryptor/decoder 107 is falsified. Here, the program being executed by encryptor/decoder 107 is stored in a memory of the virtual machine including encryptor/decoder 107, for example. The hash value of the program is preliminarily stored as a program expected value in program expected value storage 75 of secure execution environment 7.

When program falsification checker 74 accepts an instruction from encryptor/decoder 107 to request encoding of the communication data or to request decoding of the communication data already encoded, program falsification checker 74 calculates the hash value of the program being executed by encryptor/decoder 107, and compares the calculated hash value to the program expected value (hash value) stored in program expected value storage 75. When these hash values match, program falsification checker 74 determines that the program being executed is not falsified. In this case, secure execution environment 7 outputs the encoded communication data or the decoded communication data to encryptor/decoder 107.

On the other hand, when these hash values do not match, program falsification checker 74 determines that the program being executed is falsified. In this case, secure execution environment 7 does not output the encoded communication data or the decoded communication data to encryptor/decoder 107.

Secure execution environment 7 need not include program falsification checker 74 and program expected value storage 75. In this case, secure execution environment 7 outputs the encoded communication data or the decoded communication data to encryptor/decoder 107 without determining whether the program being executed by encryptor/decoder 107 is falsified.

In the above modification, the cipher key is used only within secure execution environment 7 less vulnerable to an attack from an attacker, leading to a merit that the cipher key is difficult to leak. At this time, in such an attack, it is assumed that the attacker creates and executes a fraudulent program to fraudulently activate secure execution environment 7, inputs a segment-unique parameter and a message or an encoded message specified by the attacker, and thereby fraudulently obtains an encoded or decoded message. However, in the above modification, program falsification checker 74 checks the legitimacy of a program to instruct encoding or decoding, and outputs an encoded or decoded message. This makes secure execution environment 7 less vulnerable to such an attack. As described above, the above modification has a merit that the confidentiality and completeness of the communication data are difficult to impair.

To be noted, for example, the order of the steps in the flowchart to be executed is illustrative for specifically describing the present disclosure, but the steps may be executed in any other order. Alternatively, part of the steps above may be executed simultaneously (concomitantly) with other steps, or part of the steps need not be executed.

The division of functional blocks in the block diagram is one example. A plurality of functional blocks may be implemented as one functional block, one functional block may be divided into a plurality of functional blocks, or part of the functions may be transferred to another functional block. Alternatively, the functions of a plurality of functional blocks having similar functions may be processed in parallel or in a time-sharing manner by a single item of hardware or software.

Moreover, the components described in the above embodiment and the like may be implemented as software, or may be typically implemented as LSI as an integrated circuit. These may be individually formed as a single chip, or part or all of them may be included and formed into a single chip. The LSI used may be referred to as IC, system LSI, super LSI, or ultra LSI depending on the difference in integration density. The method of forming the integrated circuit is not limited to LSI, and the integrated circuit may be implemented by a dedicated circuit (general-purpose circuit which executes the dedicated program) or by a general purpose processor. Alternatively, a field programmable gate array (FPGA) programmable after manufacturing of LSI or a reconfigurable processor allowing reconfiguration of connection or setting of the circuit cells within the LSI may be used. Further, if an integrated circuit forming technique replacing LSI due to progress of the semiconductor technique or another technique derived therefrom appears, naturally, the integration of components may be performed using the technique.

The system LSI is ultra-multifunctional LSI manufactured by integrating a plurality of processors on a single chip, and specifically is a computer system configured with a microprocessor, a ROM, a RAM, and the like. The ROM stores a computer program. The microprocessor operates according to the computer program, and the system LSI achieves the function.

One aspect of the present disclosure may be a computer program for causing a computer to execute characteristic steps included in the communication protection method illustrated in FIG. 7.

For example, the program may be program to be executed by a computer. Alternatively, one aspect of the present disclosure may be a non-transitory computer-readable recording medium on which such a program are recorded. For example, such a program may be recorded on a recording medium, which may be distributed or circulated. For example, a distributed program is installed on a device including another processor, and is executed by the processor. This can cause the device to perform the processings described above.

Besides, the present disclosure also covers embodiments obtained by subjecting the embodiment to a variety of modifications conceived by persons skilled in the art, and any combinations of the components and functions in embodiments without departing from the gist of the present disclosure.

### SUMMARY

As described above, communication protection system 100 according to a first aspect is communication protection system 100 provided in a vehicle, and includes receiver 101, transfer destination determiner 102, identifier 103, determiner 104, encryptor/decoder (encryptor) 107, and data transferer 108. Receiver 101 receives communication data. Transfer destination determiner 102 determines a transfer destination of the communication data. Identifier 103 identifies an affiliation of a sending source of the communication data and an affiliation of a transfer destination of the communication data. Determiner 104 determines whether to encode the communication data based on the affiliation of the sending source and the affiliation of the transfer destination which are identified. When encryptor/decoder 107 has determined to encode the communication data, encryptor/decoder 107 outputs the encoded communication data. Data transferer 108 transfers the communication data to the transfer destination.

In such a configuration, because the communication data is encoded, the communication data is less likely to be intercepted or falsified by software affiliation to an ECU or segment different from an ECU or segment to which communication protection system 100 belongs. This leads to a merit that the confidentiality and completeness of the communication data are difficult to impair. In such a configuration, instead of encoding all the items of communication data, only communication data to be encoded is encoded based on the affiliation of the virtual machine of the sending source and that of the virtual machine as the transfer destination, which leads to a merit that communication delay caused by encoding processing is likely to be suppressed.

In communication protection system 100 according to a second aspect, communication protection system 100 in the first aspect belongs to at least one or more segments among a plurality of segments logically divided. Determiner 104 determines to encode the communication data when the communication data is transmitted via a segment different from the one or more segments.

In such a configuration, for example, the communication data is encoded when the virtual machine transmits the communication data via a segment different from the segment to which the virtual machine belongs. This leads to a merit that the confidentiality and completeness of the communication data are difficult to impair.

In communication protection system 100 according to a third aspect, communication protection system 100 in the first or second aspect belongs to any one ECU among a plurality of ECUs. When the communication data is transmitted via an ECU different from the one ECU, determiner 104 determines to encode the communication data.

In such a configuration, the communication data is encoded when an ECU transmits the communication data via another ECU different from the ECU, for example. This leads to a merit that the confidentiality and completeness of the communication data are difficult to impair.

In communication protection system 100 according to a fourth aspect, communication protection system 100 in any one of the first to third aspects belongs to at least one or more segments among a plurality of segments logically divided, and stores a cipher key corresponding to the one or more segments. Encryptor/decoder 107 encodes the communication data using the cipher key.

In such a configuration, the communication data is encoded using the cipher key preliminarily stored, which leads to a merit that a delay of communication is less likely to occur than in a case where a cipher key is generated for each encoding.

In communication protection system 100 according to a fifth aspect, communication protection system 100 in any one of the first to third aspects further includes secure execution environment 7. Secure execution environment 7 is less likely to be falsified by an attacker than in an execution environment in which encryptor/decoder 107 executes a program, and stores a unique secret parameter. In response to a request from encryptor/decoder 107, secure execution environment 7 generates a cipher key based on the unique secret parameter, and encodes the communication data using the cipher key generated.

In such a configuration, for each encoding of the communication data, the cipher key is generated in secure execution environment 7 that is less likely to be falsified by the attacker, and the communication data is encoded. This leads to a merit that the confidentiality and completeness of the communication data are more difficult to impair than in the case where the cipher key preliminarily stored is used.

In communication protection system 100 according to a sixth aspect, secure execution environment 7 in the fifth aspect determines whether a program to be executed by encryptor/decoder 107 is falsified, and when secure execution environment 7 has determined that the program is falsified, secure execution environment 7 does not output the communication data encoded.

Such a configuration has a merit that fraudulent encoding processing to be executed as a result of fraudulent falsification of encryptor/decoder 107 is likely to be prevented.

The communication protection method according to a seventh aspect is a communication protection method to be executed by communication protection system 100 provided in a vehicle. In the communication protection method, communication data is received. In the communication protection method, a transfer destination of the communication data is determined. In the communication protection method, an affiliation of a sending source of the communication data and an affiliation of a transfer destination of the communication data are identified. In the communication protection method, it is determined whether to encode the communication data, based on the affiliation of the sending source and the affiliation of the transfer destination which are identified. In the communication protection method, when it has been determined to encode the communication data, the communication data encoded is output. In the communication protection method, the communication data is transferred to the transfer destination.

In such a configuration, because the communication data is encoded, the communication data is less likely to be intercepted or falsified by software affiliation to an ECU or segment different from an ECU or segment to which communication protection system 100 belongs. This leads to a merit that the confidentiality and completeness of the communication data are difficult to impair. In such a configuration, instead of encoding all the items of communication data, only communication data to be encoded is encoded based on the affiliation of the virtual machine of the sending source and that of the virtual machine as the transfer destination, which leads to a merit that communication delay caused by encoding processing is likely to be suppressed.

A program according to an eighth aspect causes one or more processors to execute the communication protection method according to the seventh aspect.

In such a configuration, because the communication data is encoded, the communication data is less likely to be intercepted or falsified by software affiliation to an ECU or segment different from an ECU or segment to which communication protection system 100 belongs. This leads to a merit that the confidentiality and completeness of the communication data are difficult to impair. In such a configuration, instead of encoding all the items of communication data, only communication data to be encoded is encoded based on the affiliation of the virtual machine of the sending source and that of the virtual machine as the transfer destination, which leads to a merit that communication delay caused by encoding processing is likely to be suppressed.

### FURTHER INFORMATION ABOUT TECHNICAL BACKGROUND TO THIS APPLICATION

The disclosures of the following patent applications including specification, drawings, and claims are incorporated herein by reference in their entirety: Japanese Patent Application No. 2024-038139 filed on Mar. 12, 2024, and Japanese Patent Application No. 2024-095140 filed on Jun. 12, 2024.

### INDUSTRIAL APPLICABILITY

The present disclosure is applicable to in-vehicle networks and the like.

1. A communication protection system provided in a vehicle, the communication protection system comprising:
a receiver that receives communication data;
a transfer destination determiner that determines a transfer destination of the communication data;
an identifier that identifies an affiliation of a sending source of the communication data and an affiliation of the transfer destination of the communication data;
a determiner that determines whether to encode the communication data, based on the affiliation of the sending source and the affiliation of the transfer destination which are identified;
an encryptor that outputs the communication data encoded when the determiner has determined to encode the communication data; and
a data transferer that transfers the communication data to the transfer destination.

2. The communication protection system according to claim 1,
wherein the communication protection system belongs to at least one or more segments among a plurality of segments logically divided, and
the determiner determines to encode the communication data when the communication data is transmitted via a segment different from the one or more segments.

3. The communication protection system according to claim 1,
wherein the communication protection system belongs to one electronic control unit (ECU) among a plurality of ECUs, and
the determiner determines to encode the communication data when the communication data is transmitted via an ECU different from the one ECU.

4. The communication protection system according to claim 1,
wherein the communication protection system belongs to at least one or more segments among a plurality of segments logically divided, and stores a cipher key corresponding to the one or more segments, and
the encryptor encodes the communication data using the cipher key.

5. The communication protection system according to claim 1, further comprising:
a secure execution environment that is less likely to be falsified by an attacker than in an execution environment in which the encryptor executes a program, and stores a unique secret parameter, wherein
in response to a request from the encryptor, the secure execution environment generates a cipher key based on the unique secret parameter, and encodes the communication data using the cipher key generated.

6. The communication protection system according to claim 5,
wherein the secure execution environment determines whether the program to be executed by the encryptor is falsified, and
when the secure execution environment has determined that the program is falsified, the secure execution environment does not output the communication data encoded.

7. A communication protection method to be executed by a communication protection system provided in a vehicle, the communication protection method comprising:
receiving communication data;
determining a transfer destination of the communication data;
identifying an affiliation of a sending source of the communication data and an affiliation of a transfer destination of the communication data;
determining whether to encode the communication data based on the affiliation of the sending source and the affiliation of the transfer destination which are identified;
outputting the communication data encoded when it has been determined to encode the communication data; and
transferring the communication data to the transfer destination.
